(19) United States
(12) Patent Application Publication
(10) Pub. No.: US 2011/0187870 A1
(43) Pub. Date: Aug. 4, 2011

(54) Video/Audio Module Applied to Computer System

(75) Inventors: Chi-Tung Chang, Taipei (TW); Wen-Chao Tseng, Taipei (TW); I-Chieh Lin, Taipei (TW)

(73) Assignee: Alcor Micro Corp., Taipei (TW)

(21) Appl. No.: 12/750,728

(22) Filed: Mar. 31, 2010

(30) Foreign Application Priority Data
Jan. 29, 2010 (TW) 099102492

(51) Int. Cl. H04N 5/225; H04R 3/00; G06F 17/00

(52) U.S. Cl. 348/207.1; 381/122; 700/94; 348/E05.024

(57) ABSTRACT

The present invention discloses a video/audio module applied to a computer system. The video/audio module includes a circuit board, at least one analog microphone unit, and at least one analog-to-digital converter. The analog microphone unit and the analog-to-digital converter are electrically connected and fixed to the circuit board. The analog microphone unit captures an audio signal from ambient air and converts it to an analog audio signal. The analog-to-digital converter receives the analog audio signal and transforms the analog audio signal into a digital audio signal. Because of the analog-to-digital converter, a digital microphone unit can be replaced by the analog microphone unit, thereby reducing the production cost of the video/audio module.

### BACKGROUND OF THE INVENTION

1. Technical Field

The present invention relates to a video/audio module applied to a computer system, and more particularly, a video/audio module that is more suitable for a laptop computer or an all-in-one computer.

2. Description of Related Art

With the development of modern internet infrastructure, people have required more and more from voice communication devices built with computing devices. Responding to such a trend, audio sensors that capture voice data and image sensors that capture images or video/audio sensors (e.g. web-cams) that incorporate the functions of both have become indispensable to currently prevalent portable computers (e.g. tablet computers, laptop computers, etc.) and all-in-one computers.

However, existing portable computers and all-in-one computers typically have their video/audio module settled above the LCD, causing the video/audio module to be distant from the motherboard of the host processing unit. In addition, for preventing the audio signals or the image signals from being subject to the interference from the LCD and motherboard, it is necessary to transmit them in the form of digital signal streams so as to ensure the quality of the audio and image signals and provide the host processing unit with intact audio and image data.

FIG. 1 is a block diagram of a conventional video/audio module 10. As shown in FIG. 1, the conventional video/audio module 10 at least includes two digital microphone units 11, an image sensor 12, a controller 13 and a USB (universal-serial-bus) interface 14.

Each said digital microphone unit 11 has a transducer 111 and an analog-to-digital converter 112. Therein, the transducer 111 serves to convert the captured audio signals from ambient air into analog audio signals Then the analog-to-digital converter 112 further converts the analog audio signals into digital audio signals, and outputs the same to the controller 13. The image sensor 12 also converts the images into digital image signals and outputs the same to the controller 13. Then, the controller 13 integrates and processes the digital image signals and the digital audio signals into digital signals to be transmitted to the host processing unit through the USB interface 14.

Since the conventional video/audio module has to communicate with the motherboard of the host processing unit through a relatively long cable sufficient for bypassing the LCD and motherboard, the signals are still subject to noise disturbance. Thus, it is necessary to use a digital microphone unit to ensure the quality of the audio signals and image signals transmitted through the cable. However, the high production cost of digital microphone units hinders the production cost of existing video/audio modules from being reasonably reduced, and in turn hinders the production cost of the portable computers and all-in-one computers from being further trimmed.

### BRIEF SUMMARY OF THE INVENTION

The present invention provides a video/audio module applied to a computer system, which uses an analog microphone unit to replace a conventional required digital microphone unit, so as to reduce the production cost.

The present invention provides a video/audio module applied to a computer system, wherein the video/audio module is equipped with an analog-to-digital converter that is incorporated into a controller so as to secure the quality of audio signals from noise disturbance and reduce the production cost.

To achieve the aforementioned effects, the video/audio module of the present invention comprises a circuit board; at least one analog microphone unit electrically connected and fixed to the circuit board for capturing an audio signal from ambient air and outputting an analog audio signal; and at least one analog-to-digital converter electrically connected and fixed to the circuit board and having an input end exclusively in signal connection with one said analog microphone unit for converting the analog audio signal into a digital audio signal and outputting the digital audio signal.

To achieve the aforementioned effects, the video/audio module of the present invention alternatively comprises a circuit board; two analog microphone units electrically connected and fixed to the circuit board for capturing an audio signal from ambient air and outputting an analog audio signal; an image sensor electrically connected and fixed to the circuit board for capturing an image signal and outputting a digital image signal; a controller electrically connected and fixed to the circuit board for receiving the analog audio signal and the digital image signal, wherein the controller has two analog-to-digital converters each having an input end exclusively in signal connection with one said analog microphone unit for converting the analog audio signal into a digital audio signal and outputting the digital audio signal; a pulse-density-modulation interface in signal connection with output ends of the analog-to-digital converters for transmitting the digital audio signal to a host processing unit of the computer system; and a USB interface for receiving the digital image signal and transmitting the digital image signal to the host processing unit; a connector electrically connected and fixed to the circuit board and having a connecting cable that connects the pulse-density-modulation interface, the USB interface and a power source as well as a grounding wire required by the video/audio module to the host processing unit; and a voltage converter electrically connected and fixed to the circuit board and having an output end electrically connected to the analog microphone units, the image sensor and the controller so as to convert power from the power source into power of voltages suitable for the analog microphone units, the image sensor and the controller.

By implementing the present invention, at least the following progressive effects can be achieved:

1. By replacing a digital microphone unit with an analog microphone unit in the video/audio module, the production cost of the video/audio module can be effectively reduced.

2. By integrating the analog-to-digital converter and the controller into the single chip, the purposes of saving cost and securing the audio signals from deterioration due to noise disturbance can be achieved.

3. The video/audio module of the present invention is adaptive to existing computers without modifying the hardware and operation systems of the computers.

### BRIEF DESCRIPTION OF THE SEVERAL VIEWS OF THE DRAWINGS

The invention as well as a preferred mode of use and advantages thereof will be best understood by referring to the following detailed description of the illustrative embodiments in conjunction with the accompanying drawings, wherein:

FIG. 1 is a block diagram of a circuit of a conventional video/audio module;

FIG. 2A is a perspective view of a video/audio module applied to a computer system according to a first embodiment of the present invention;

FIG. 2B is a perspective view of a video/audio module applied to a computer system according to a second embodiment of the present invention;

FIG. 3 shows a first applied aspect of the video/audio module according to the present invention;

FIG. 4 shows a second applied aspect of the video/audio module according to the present invention;

FIG. 5 shows a third applied aspect of the video/audio module according to the present invention;

FIG. 6 shows a fourth applied aspect of the video/audio module according to the present invention; and

FIG. 7 is an application of the video/audio module of the present invention.

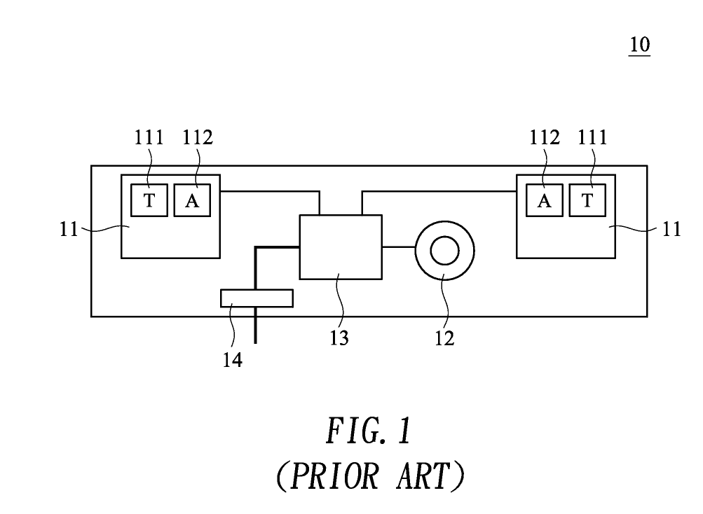

### DETAILED DESCRIPTION OF THE INVENTION

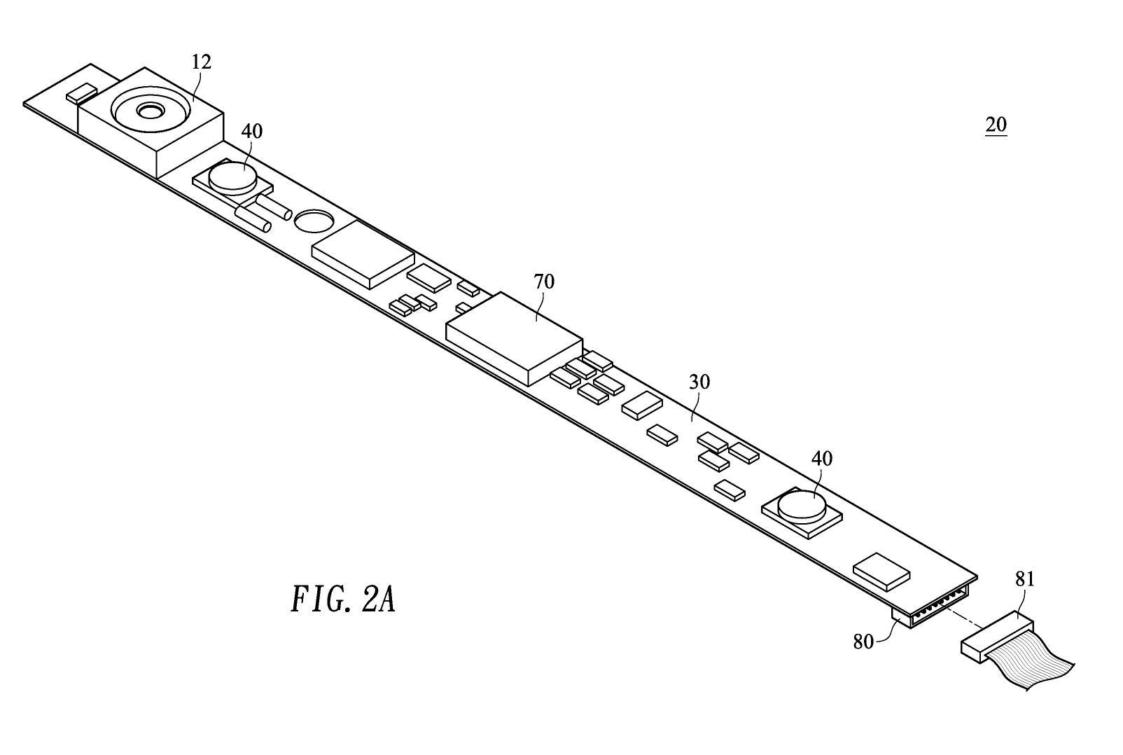

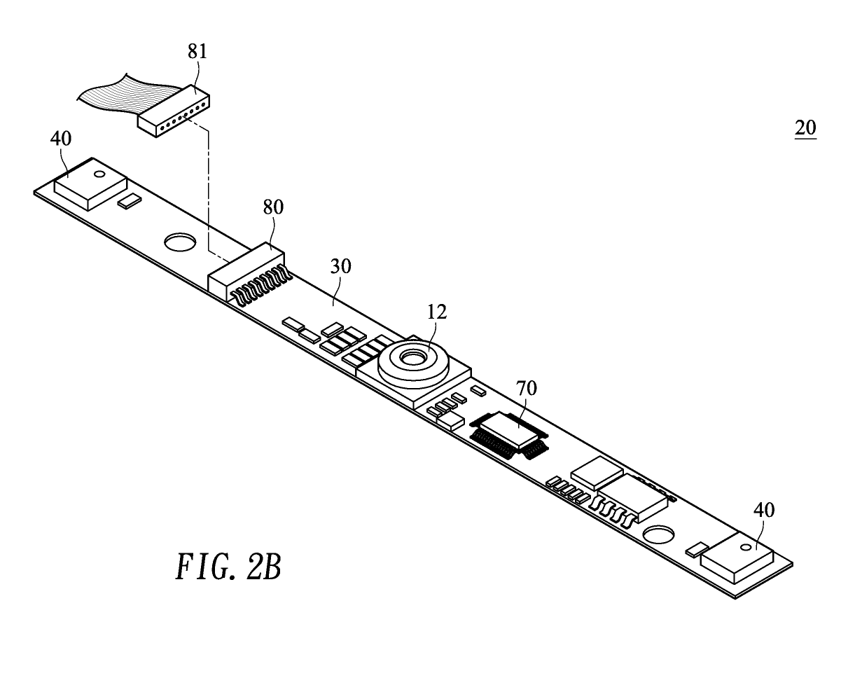

Referring to FIG. 2A and FIG. 2B, one embodiment of the present invention provides a video/audio module 20 applied to a computer system. The video/audio module 20 includes a circuit board 30, at least one analog microphone unit 40 and at least one analog-to-digital converter.

As shown in FIG. 2A and FIG. 2B, the circuit board 30 serves to carry various electronic elements required for supporting the video/audio module 20. The circuit board 30 is configured to allow electrical connection between the electronic elements and in turn allow signal transmission.

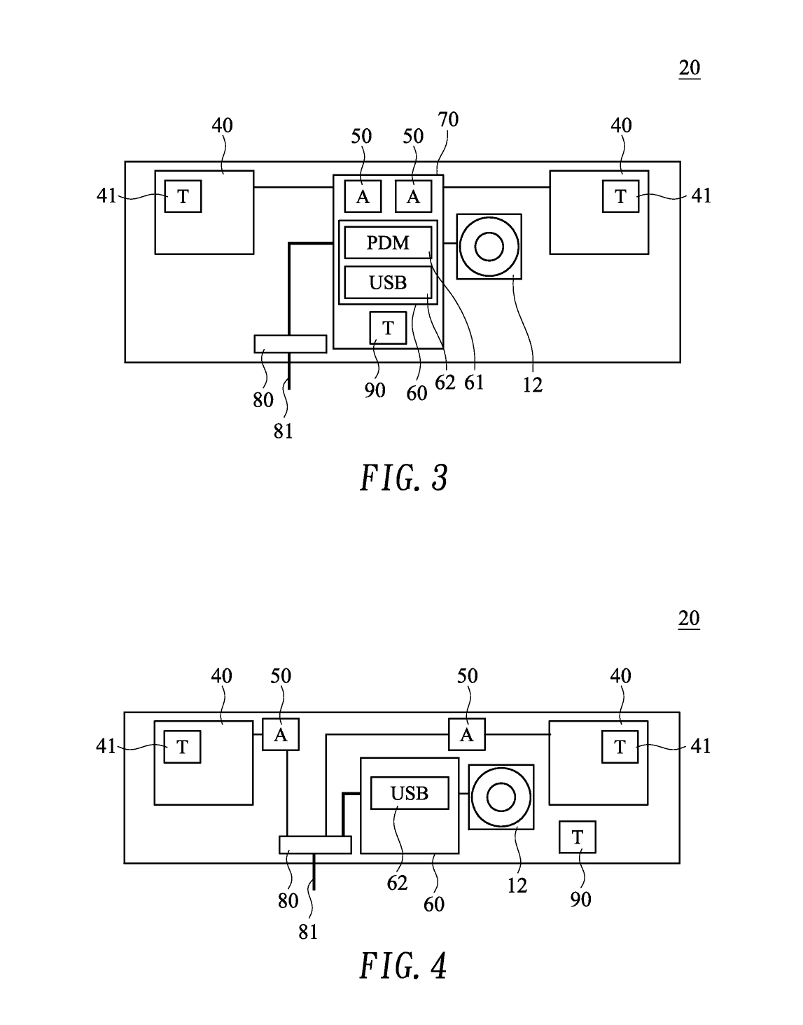

The analog microphone unit 40 is electrically connected and fixed to the circuit board 30 for receiving voice data from the exterior and capture an audio signal from ambient air. The analog microphone unit 40 contains therein a transducer 41 (as shown in FIG. 3 through FIG. 6) for converting the audio signal into an analog audio signal and outputting the same. In the present embodiment, two said analog microphone units 40 are adopted and arranged at two ends of the circuit board 30, respectively, for receiving voice data from different positions in the environment and further providing voice data to the spatial filtering process. While having been quite mature and extensively applied in various applications such as eliminating environmental noise by using a microphone-unit array, the spatial filtering technology is known to people skilled in the art and need not be described in any detail herein.

The analog-to-digital converter 40 is electrically connected and fixed to the circuit board (not shown). As shown in FIG. 3 through FIG. 6, multiple analog-to-digital converters 50 each have an input end exclusively in signal connection with one said analog microphone unit 40. The analog-to-digital converters 50 serve to convert the analog audio signal into a digital audio signal, which is then outputted.

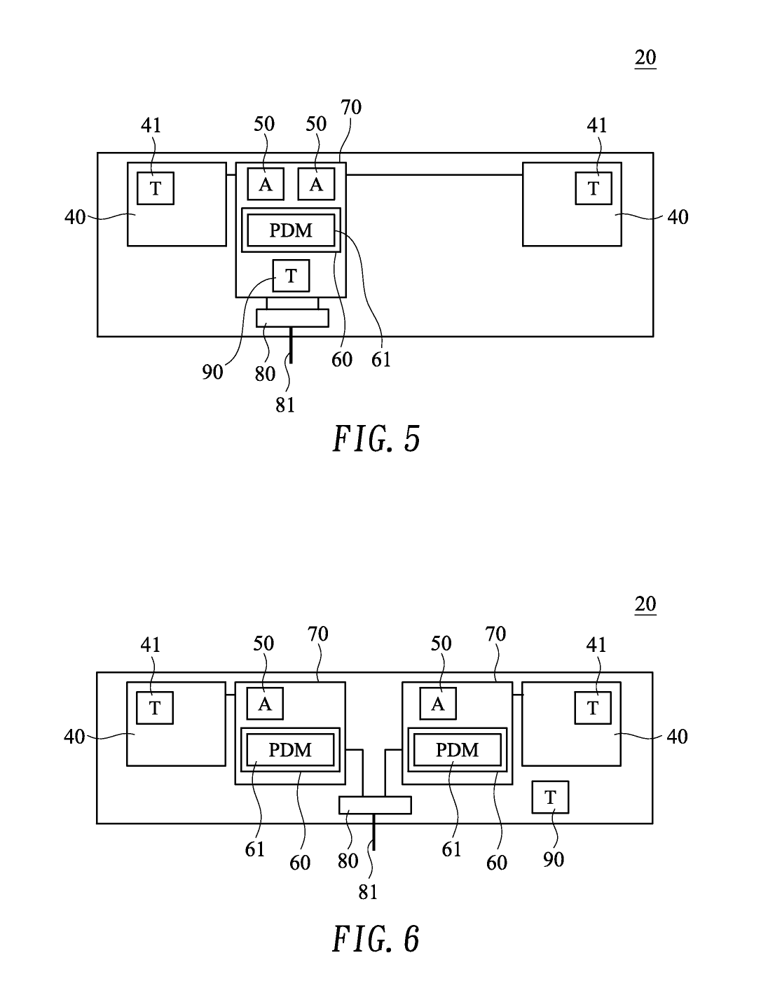

The circuit board 30 may further have a controller (not shown) fixed thereto. Referring to FIG. 3, FIG. 5, and FIG. 6, the controller 60 may have a digital transmission interface 61 (such as a pulse-density-modulation interface). The digital transmission interface 61 is in signal connection with output ends of the analog-to-digital converter 50 so as to transmit the digital audio signal to the host processing unit. Since the digital audio signal is more resistant to noise, the quality of the transmitted audio signal can be thereby ensured.

The analog-to-digital converter and the controller may be provided as two separate elements 50 and 60, as shown in FIG. 4, or may be integrated as a single chip 70, like that reflected in FIG. 3, FIG. 5, and FIG. 6. The single chip 70 incorporating both the analog-to-digital converter 50 and the controller 60 may be fixed to the circuit board 30 (as depicted in FIG. 2A and FIG. 2B). Moreover, referring to FIG. 6, when the video/audio module 20 includes two said analog microphone units 40, two said single chips 70 composed of the analog-to-digital converters 50 and the controllers 60 may be implemented so as to make each said analog microphone unit 40 possess one said single chip 70 corresponding thereto.

Referring to FIG. 2A and FIG. 2B, the video/audio module 20 may further have at least one image sensor 12 for capturing an image signal and converting the image signal into a digital image signal to be output to the controller 60 (as shown in FIG. 3 and FIG. 4). Therein, the image sensor 12 may be a CMOS image sensor or a CCD image sensor. As shown in FIG. 2A and FIG. 2B, the image sensor 12 is electrically connected and fixed to the circuit board 30, while the analog microphone units 40 may be settled at a same side of the image sensor 12 (as shown in FIG. 2A) or flank the image sensor 12 (as shown in FIG. 2B).

Furthermore, referring to FIG. 3 and FIG. 4, the controller 60 may further have a USB interface 62 for receiving the digital image signal from the image sensor 12 and transmitting the digital image signal to the host processing unit.

Referring to FIG. 2A and FIG. 2B, the video/audio module 20 may further have a connector 80 and a connecting cable 81. The connector 80 is also electrically connected and fixed to the circuit board 30 and serves to connect a power source and a grounding wire required by the USB interface 62 (as shown in FIG. 3) and the video/audio module 20. The connecting cable 81 is removably connected to the connector 80 electrically and connects the power source and the grounding wire required by the USB interface 62 and the video/audio module 20 to the host processing unit.

Moreover, as shown in FIG. 3, FIG. 5, and FIG. 6, when the controller 60 contains the digital transmission interface 61, the connector 80 may be also connected to the power source and the grounding wire required by the digital transmission interface 61 and the video/audio module 20, and the connecting cable 81 may also connect the power source and the grounding wire required by the digital transmission interface 61 and the video/audio module 20 to the host processing unit.

Therefore, as shown in FIG. 2A and FIG. 2B, the circuit board 30 is fixedly mounted with the analog microphone unit 40, the single chip 70 integrating the analog-to-digital converter and the controller, the connector 80 and the image sensor 12. In view of the above, the forgoing electronic elements may need power of different voltages, or some of the electronic elements may need the power of two or more voltages, the video/audio module 20 may further have a voltage converter 90 (as shown in FIG. 3 through FIG. 6) that is also electrically connected and fixed to the circuit board 30.

The voltage converter 90 has an input end electrically connected to the connector 80, so as to be electrically connected with the power source through the connector 80 and convert power from the power source into voltages suitable for the electronic elements. The voltage converter 90 has an output end electrically connected to the electronic elements in the video/audio module 20, so as to supply the electronic elements with the voltages they need. In other words, the voltage converter 90 serves to convert power into voltages suitable for the analog microphone units 40, the image sensor 12, the controller 60, and the analog-to-digital converter 50 or for the single chip 70 composed of the controller 60 and the analog-to-digital converter 50.

In addition, the voltage converter 90 may be integrated into the single chip 70 that contains the analog-to-digital converter 50 and the controller 60 (as shown in FIG. 3 and FIG. 5) or may be provided separately (as shown in FIG. 4 and FIG. 6).

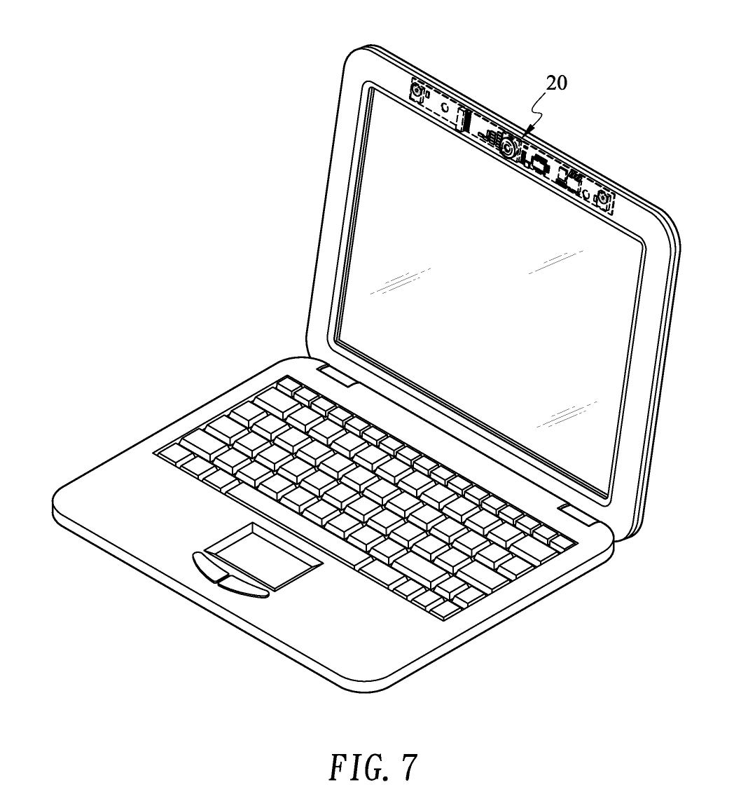

The video/audio module 20 is shown as applied to a tablet computer, an all-in-one computer, or a laptop computer as depicted in FIG. 7. By virtue of the analog-to-digital converter, the video/audio module 20 allows the use of the analog microphone unit so as to reduce the production cost of the video/audio module 20. Additionally, while using with the video/audio module 20, the host processing unit needs no modification to its motherboard or application programs. That is to say, the video/audio module 20 of the present invention can be easily applied to any existing host processing unit.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A video/audio module applied to a computer system, the video/audio module comprising:
a circuit board;
at least one analog microphone unit electrically connected and fixed to the circuit board for capturing an audio signal and outputting an analog audio signal; and
at least one analog-to-digital converter electrically connected and fixed to the circuit board and having an input end exclusively in signal connection with one said analog microphone unit for converting the analog audio signal into a digital audio signal and outputting the digital audio signal.

2. The video/audio module of claim 1, having at least two said analog microphone units.

3. The video/audio module of claim 1, further having a controller that includes a digital transmission interface, which is in signal connection with an output end of the analog-to-digital converter for transmitting the digital audio signal to a host processing unit of the computer system.

4. The video/audio module of claim 3, wherein the digital transmission interface is a pulse-density-modulation interface.

5. The video/audio module of claim 3, wherein the analog-to-digital converter and the controller are integrated into a single chip.

6. The video/audio module of claim 3, further having a connector that is electrically connected and fixed to the circuit board for connecting a power source and a grounding wire required by the digital transmission interface and the video/audio module.

7. The video/audio module of claim 6, further having a connecting cable that is removably connected with the connector electrically for connecting the power source and the grounding wire required by the digital transmission interface and the video/audio module to the host processing unit of the computer system.

8. The video/audio module of claim 1, further having at least one image sensor and a controller that are electrically connected and fixed to the circuit board, wherein the image sensor captures an image signal and outputs a digital image signal to the controller.

9. The video/audio module of claim 8, wherein the image sensor is a CMOS image sensor or a CCD image sensor.

10. The video/audio module of claim 8, wherein the controller further having a USB interface for receiving the digital image signal and transmitting the digital image signal to a host processing unit of the computer system.

11. The video/audio module of claim 10, further having a connector that is electrically connected and fixed to the circuit board for connecting a power source and a grounding wire required by the USB interface and the video/audio module.

12. The video/audio module of claim 11, further having a connecting cable that is removably connected to the connector electrically for connecting the power source and the grounding wire required by the USB interface and the video/audio module to the host processing unit of the computer system.

13. The video/audio module of claim 1, further having a voltage converter that is electrically connected and fixed to the circuit board, wherein the voltage converter has an output end electrically connected to electronic elements in the video/audio module.

14. The video/audio module of claim 13, wherein the voltage converter and the controller are integrated in a single chip.

15. A video/audio module applied to a computer system, the video/audio module comprising:
a circuit board;
two analog microphone units electrically connected and fixed to the circuit board for capturing an audio signal and outputting an analog audio signal;
an image sensor electrically connected and fixed to the circuit board for capturing an image signal and outputting a digital image signal;
a controller electrically connected and fixed to the circuit board for receiving the analog audio signal and the digital image signal, and the controller having:
two analog-to-digital converters each having an input end exclusively in signal connection with one said analog microphone unit for converting the analog audio signal into a digital audio signal and outputting the digital audio signal;
a pulse-density-modulation interface in signal connection with output ends of the analog-to-digital converters for transmitting the digital audio signal to a host processing unit of the computer system; and
a USB interface for receiving the digital image signal and transmitting the digital image signal to the host processing unit;
a connector electrically connected and fixed to the circuit board and having a connecting cable that connects the pulse-density-modulation interface, the USB interface and a power source as well as a grounding wire required by the video/audio module to the host processing unit; and
a voltage converter electrically connected and fixed to the circuit board and having an output end electrically connected to the analog microphone units, the image sensor and the controller so as to convert power from the power source into power of voltages suitable for the analog microphone units, the image sensor and the controller.

16. The video/audio module of claim 15, wherein the image sensor is a CMOS image sensor or a CCD image sensor.

17. The video/audio module of claim 15, wherein the voltage converter and the controller is integrated into a single chip.
